(19) United States
(12) Patent Application Publication
(10) Pub. No.: US 2017/0239801 A1
(43) Pub. Date: Aug. 24, 2017

(54) ANGLE TOOL

(71) Applicant: MAKITA CORPORATION, Anjo-shi (JP)

(72) Inventors: Tomoyuki KONDO, Anjo-shi (JP); Tokuo HIRABAYASHI, Anjo-shi (JP); Hidenori NAGASAKA, Anjo-shi (JP)

(73) Assignee: MAKITA CORPORATION, Anjo-shi (JP)

(21) Appl. No.: 15/410,322

(22) Filed: Jan. 19, 2017

(30) Foreign Application Priority Data
Feb. 22, 2016 (JP) 2016-031318

(51) Int. Cl. B25F 5/00; B25B 21/02

(52) U.S. Cl. CPC B25F 5/001; B25B 21/02

(57) ABSTRACT

An angle tool having an output shaft part the height of which is low is provided. The angle tool includes an output shaft having a chuck part capable of holding a bit, a shaft that is provided so as to intersect the output shaft and that transmits drive force to the output shaft, and a gear housing that accommodates the shaft. The entirety of the chuck part is disposed in the gear housing. The output shaft includes a bevel gear that receives drive force from the shaft, and the chuck part is disposed inside the bevel gear. The chuck part is disposed in front of the shaft so as to intersect an extended line of a center axis of the shaft.

### BACKGROUND OF THE INVENTION

This application claims the benefit of Japanese Patent Application Number 2016-031318 filed on Feb. 22, 2016, the entirety of which is incorporated by reference.

### FIELD OF THE INVENTION

The present invention relates to an angle tool having an output shaft which is disposed to have an angle relative to a motor shaft.

### DESCRIPTION OF THE BACKGROUND ART

As disclosed in Japanese Laid-Open Patent Publication No. 2014-200884, an angle impact driver in which an output shaft rotates around the axial line intersecting the rotation axis of a motor is known. A bit is attached to the output shaft.

The output shaft is supported by an upper output bearing on the upper side and a lower output bearing, on the lower side, disposed in a direction in which the bit protrudes, such that the output shaft is capable of rotating around the central axis of the output shaft itself while oriented in the up and down direction. The lower output bearing also has a role to cover an internal mechanism. The output shaft includes a bevel gear part, and is rotationally driven by a shaft which extends in the front and rear direction and which has a bevel gear part disposed therebehind.

The output shaft further includes a chuck part that holds a bit. The chuck part includes a chuck ball that enters a small recess in the bit, and a sleeve that is slid to maintain or release a state in which the chuck ball is in the small recess in the bit. The sleeve is arranged below the lower output bearing to be operated, and the chuck ball is also arranged below the lower output bearing.

### SUMMARY OF THE INVENTION

In an output shaft of a conventional angle impact driver as described above, a chuck ball and a sleeve are required to be arranged below a lower output bearing while a bevel gear part and an upper output bearing are provided, and, thus, the length in the output shaft direction (the height of the output shaft part in the up and down direction) becomes long.

Therefore, a main object of the present invention is to provide an angle tool in which an output shaft part has a reduced height.

In order to achieve the above object, a first aspect of the present invention is an angle tool that includes an output shaft including a bit holding part capable of holding a bit, a drive shaft provided so as to intersect the output shaft and configured to transmit drive force to the output shaft, and a housing configured to accommodate the drive shaft. The entirety of the bit holding part may be disposed in the housing.

According to a second aspect of the present invention, in the above aspect, the output shaft may include a gear that receives drive force from the drive shaft, and the bit holding part may be disposed inside the gear.

According to a third aspect of the present invention, in the above aspect, the bit holding part may be disposed in front of the drive shaft so as to intersect an extended line of a central axis of the drive shaft.

According to a fourth aspect of the present invention, in the above aspect, bit holding releasing means for releasing holding of the bit, and linking means connected to the bit holding releasing means, may be further provided. The bit holding releasing means may be accommodated in the housing, and at least a part of the linking means may be disposed outside the housing.

According to a fifth aspect of the present invention, in the above aspect, the linking means may be an arm that has an L-shaped cross-section and may have a bearing part at a corner portion of the arm.

According to a sixth aspect of the present invention, in the above aspect, the output shaft may have a communication hole connected to the bit holding part, and the housing may have a housing hole connected to the communication hole.

According to a seventh aspect of the present invention, in the above aspect, a cap that covers at least one of the communication hole and the housing hole may be provided.

According to an eighth aspect of the present invention, in the above aspect, the cap may have a screw section and the housing hole may have a screw receiving section which meshes with the screw section.

In order to achieve the above object, a ninth aspect of the present invention is an angle tool that includes a motor, a drive shaft that is driven by the motor, an output shaft configured to form an angle relative to the drive shaft and be driven by the drive shaft, a hexagonal hole formed in the output shaft, a locking member capable of protruding from a wall defining the hexagonal hole, and a housing configured to support the output shaft and accommodate the locking member.

According to the present invention, an angle tool having an output shaft part the height of which is low can be provided.

### BRIEF DESCRIPTION OF THE DRAWINGS

FIG. 1 is a perspective view of an angle impact driver according to a first embodiment of the present invention.

FIG. 2 is a longitudinal center cross-sectional view of the angle impact driver shown in FIG. 1.

FIG. 3 is an enlarged view of a front portion of the angle impact driver shown in FIG. 1.

FIG. 4 is a horizontal center cross-sectional view of the angle impact driver shown in FIG. 1.

FIG. 5 is a front view of the angle impact driver shown in FIG. 1.

FIG. 6 is a center cross-sectional view of an angle head part shown in FIG. 5.

FIG. 7 is a perspective view of an arm shown in FIG. 1.

FIG. 8 is a perspective view of an angle impact driver according to a second embodiment of the present invention.

FIG. 9 is a horizontal center cross-sectional view of an angle head part shown in FIG. 8.

FIG. 10 is a front view of the angle impact driver shown in FIG. 8.

FIG. 11 is a center cross-sectional view of the angle head part shown in FIG. 10.

FIG. 12 is a perspective view of a sleeve shown in FIG. 8.

### DESCRIPTION OF THE PREFERRED EMBODIMENTS

Hereinafter, embodiments of the present invention and the modification thereof will be described with reference where appropriate to the drawings.

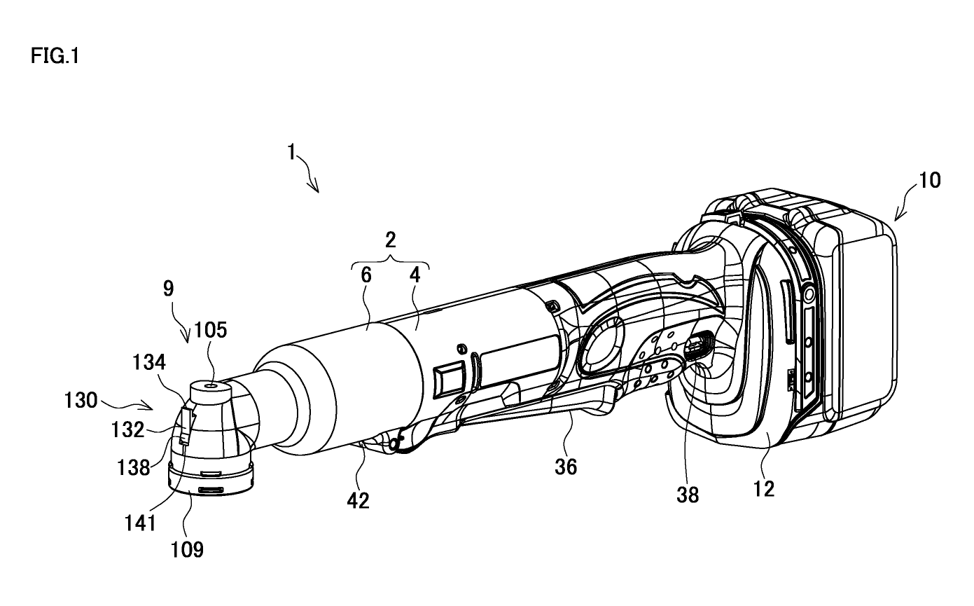

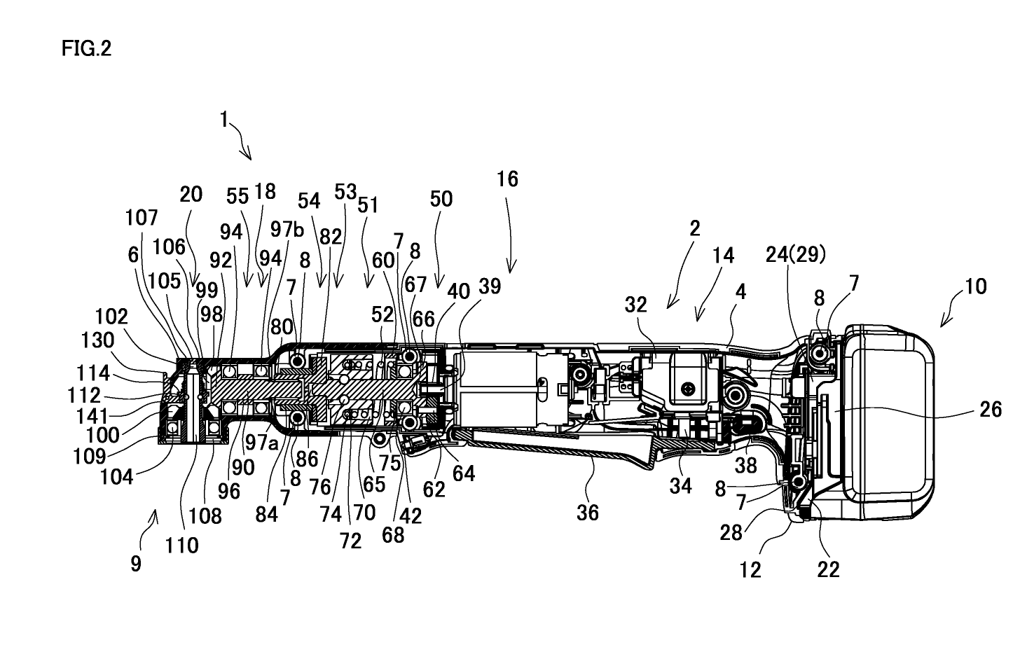

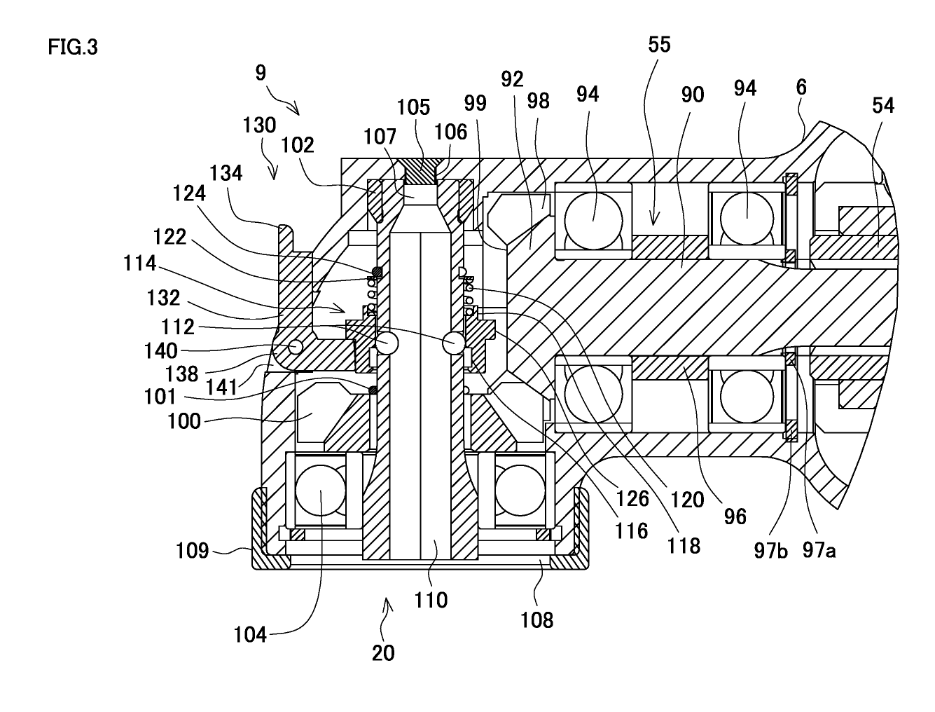

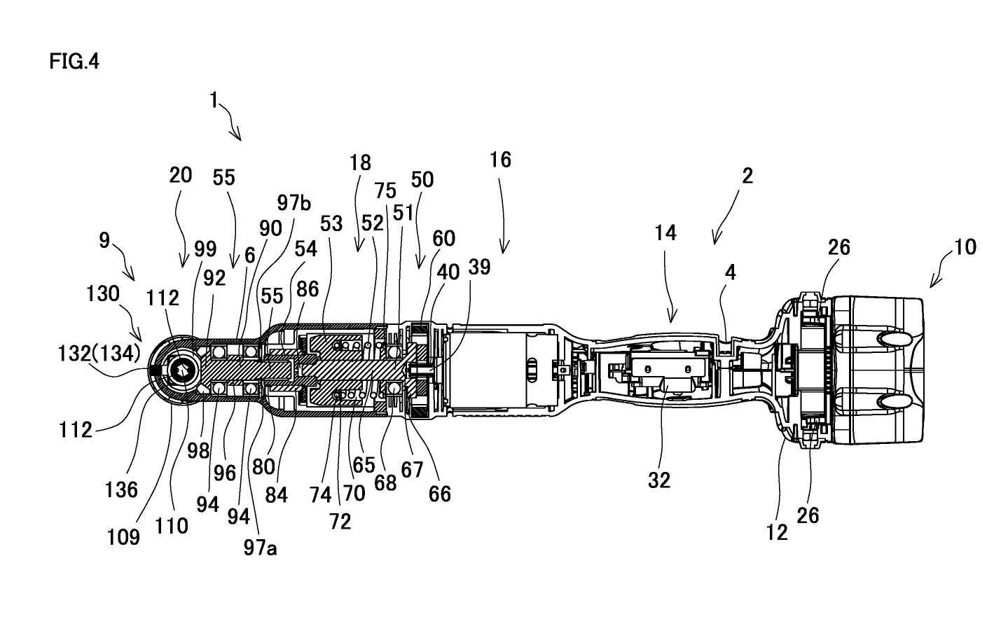

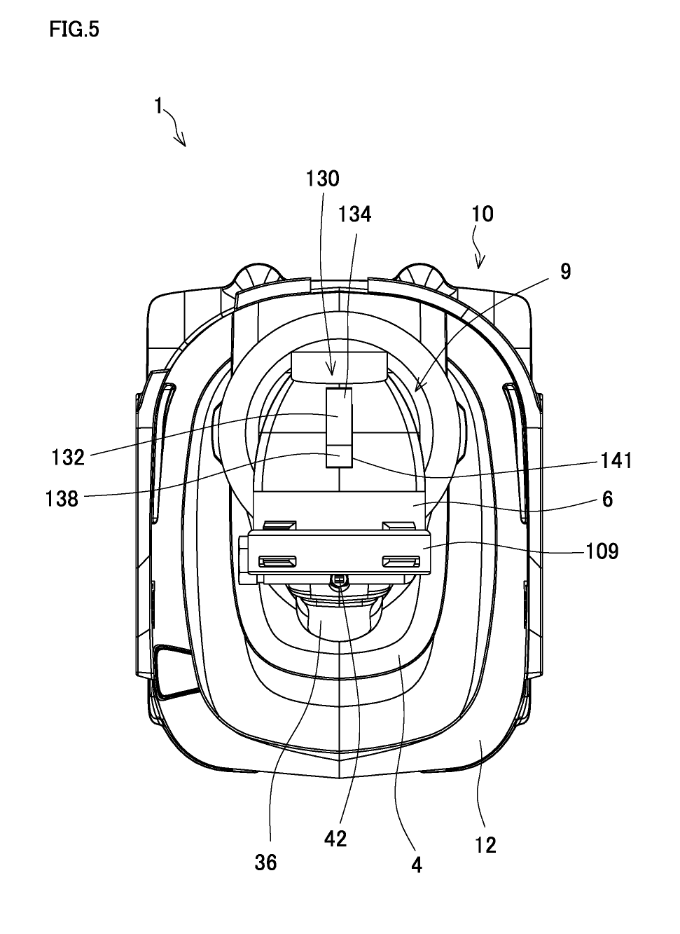

FIG. 1 is a perspective view of an angle impact driver 1 which is an example of an angle-type electric tool (an angle tool) according to a first embodiment. FIG. 2 is a longitudinal center cross-sectional view of the angle impact driver 1 shown in FIG. 1. FIG. 3 is an enlarged view of the front portion of the angle impact driver 1 shown in FIG. 1. FIG. 4 is a horizontal center cross-sectional view (in which a battery 10 is viewed from thereabove) of the angle impact driver 1 shown in FIG. 1. FIG. 5 is a front view of the angle impact driver 1 shown in FIG. 1. The “angle-type” tool refers to a tool in which a motor shaft intersects an output shaft at an angle of almost 90°. The left in FIG. 2 and FIG. 4 corresponds to the front of the angle impact driver 1.

The angle impact driver 1 has a housing 2 which forms the outer shell thereof. The housing 2 includes a motor housing 4 and a gear housing 6.

The motor housing 4 is formed into a cylindrical shape the central axis of which extends in the front-rear direction. The motor housing 4 can be halved into the left and right portions. One of the left and right portions has not-illustrated screw holes and the other thereof has boss sections 7, 7, . . . at the corresponding positions. Screws 8 are inserted through the screw holes and the corresponding boss portions 7.

The rear portion of the gear housing 6 is formed into a cylindrical shape the central axis of which extends in the front and rear direction. The rear portion of the gear housing 6 is disposed over the outer side of the front end portion of the motor housing 4. The front portion of the gear housing 6 is formed into a bell-like shape the center axis of which extends in the up and down direction, and forms an angle head part 9 including an internal mechanism therein.

At the rear end portion of the motor housing 4, a battery attachment part 12 to which a battery 10 can be attached is formed. The battery attachment part 12 spreads in the up, down, left, and right directions, with respect to a portion in front thereof, and in particular, spreads greatly in the down direction.

In front of the battery attachment part 12 in the central portion of the motor housing 4, a switch 14 is disposed.

In front of the switch 14 in the central portion of the motor housing 4, a DC driven motor 16 is accommodated as a drive source.

In a portion, in front of the motor 16, from the inside of the front portion of the motor housing 4 to the inside of the gear housing 6, a drive force transmission mechanism 18 and an output shaft 20 are accommodated.

The battery 10 is a substantially rectangular-parallelepiped rechargeable battery and has a lithium ion battery cell therein.

The battery 10 has, at the rear lower portion thereof, a button (not illustrated), for removal, which can be pressed rearward. The button for removal is urged forward by an elastic body (a spring), and is normally located along the other portion of the battery 10. Furthermore, the battery 10 has, at the front lower portion, a claw 22 which can protrude and retract with respect to the surrounding thereof. When the button for removal is at the normal position, the claw 22 is in a protruding state. When the button for removal is pressed rearward against urging force, the claw 22 enters an embedded state. The battery 10 has, at the front portion thereof, a terminal 24 and a plurality of (two) rails 26, 26 extending in the up-down direction.

The battery attachment part 12 has, in the lower portion thereof, an engagement recess section 28 which is recessed forward with respect to the surrounding. The shape of the engagement recessed section 28 corresponds to the shape of the claw 22.

Moreover, the battery attachment part 12 has, on the rear surface thereof, a terminal 29 and rail engagement sections (not illustrated) which are engaged with the corresponding rails 26 of the battery 10.

When the battery 10 is slid upward from the lower portion with respect to the battery attachment part 12 in a state where the rails 26 of the battery 10 are along the rail engagement sections, the claw 22 engages with the engagement recessed section 28, so that the battery 10 is attached. At this time, the terminal 24 of the battery 10 is engaged and in contact with the corresponding terminal 29 of the battery attachment part 12.

The rear portion of the housing 2 up to the outer portion of the center part (an outer portion in front of the battery attachment part 12 and in rear of the outer side of the motor 16) thereof is formed as a grip to be gripped by a user. A non-slip member (thermoplastic elastomer) is arranged on the grip.

The motor 16 may be a brushless motor. In this case, a control circuit board for controlling the brushless motor may be disposed inside the battery attachment part 12. A plurality of (six) switching elements and a microcomputer are mounted on the control circuit board.

The switch 14 switches the energization state of the motor 16, and is used for applying current to the motor 16.

The switch 14 includes a switch body 32, and a plunger 34 protruding downward from the lower surface of the switch body 32. When the plunger 34 is pressed upward, the switch 14 is turned on. When the plunger 34 is at the normal position without being pressed, the switch 14 is off.

Below the switch 14, a switch lever 36 is disposed in a state where a portion of the switch lever 36 is exposed from the motor housing 4. The switch lever 36 can move upward and downward about the front end portion thereof. The upper side of the rear end portion of the switch lever 36 is adjacent to the front end portion of the plunger 34. The switch lever 36 can receive a pressing operation performed by a user with a finger or the like.

Behind the switch lever 36, a forward and rearward rotation reversing switch 38 which sequentially switches the rotational direction of the motor 16 is accommodated so as to be partially exposed from the left and right sides of the motor housing 4.

The motor 16 has a rotor and a stator, and is accommodated in the motor housing 4. The stator includes a permanent magnet. The rotor includes a motor shaft 39 which is the rotation shaft. A pinion 40 is fixed to the front end portion of the motor shaft 39.

A light (LED) 42 which illuminates the front area (an area around the lower end of the output shaft 20) is provided below and in front of the motor 16.

When the motor 16 is a brushless motor, the stator may include a sensor substrate (not illustrated). Further, a lead wire for controlling rotation and a lead wire for rotation detection signals may be provided between the sensor substrate and the control circuit board. A lead wire (not illustrated) may be provided between the control circuit board and the light 42 in front thereof. A power supply lead wire (not illustrated) may be provided between the switch 14 and the control circuit board. A power supply lead wire (not illustrated) may be provided between the control circuit board and the terminal 29 of the battery attachment part 12. In this case, electricity at the terminal 29 of the battery attachment part 12 is applied to the switch 14 via the power supply wire at the terminal 29 side and the power supply lead wire at the control circuit board and switch 14 side.

The drive force transmission mechanism 18 includes a planetary gear mechanism 50, a spindle 51, a coil-shaped spring 52 as an elastic body, a hammer 53, an anvil 54, and a shaft 55, in order, respectively, from the rear side, which are coaxially accommodated.

The planetary gear mechanism 50 includes an internal gear 60 having internal teeth, a plurality of planetary gears 62, 62 . . . , each having external teeth which mesh with the internal gear 60, and pins 64 which are the shafts of the respective planetary gears 62.

The internal gear 60 is attached in the front portion of the motor housing 4 in an unrotatable manner, and is positioned inside the rear end portion of the gear housing 6.

The planetary gears 62 mesh with the pinion 40 on the outer side of the motor shaft 39 of the motor 16.

The spindle 51 has a disk-shaped part 66 on the rear side of a bar-shaped part 65 elongated in the front-rear direction. The disk-shaped part 66 protrudes outward (upward, downward, leftward, and rightward) from the bar-shaped part 65, and has a larger diameter than other parts. The rear portion of the disk-shaped part 66 is in the front portion of the internal gear 60.

In the center of the disk-shaped part 66, a spindle hole 67 extending forward from the rear surface is provided. The motor shaft 39 of the motor 16 and the front end portion (a portion which does not mesh with the planetary gears 62) of the pinion 40 are in the spindle hole 67, with a gap formed between them and the circumferential surface of the spindle hole 67.

A spindle bearing 68 which receives the spindle 51 is disposed inward of the boss sections 7, 7 disposed in the motor housing 4. The spindle bearing 68 is held in front of the planetary gear mechanism 50.

In the rear surface of the disk-shaped part 66 of the spindle 51, a plurality (corresponding to the number of the pins 64) of pin holes corresponding to the respective front end portions of the pins 64 of the planetary gears 62 are provided. In a state where the front end portions of the pins 64 are in the pin holes, the pins 64 are disposed on the rear side of the disk-shaped part 66.

The planetary gears 62 are provided around the pins 64, respectively, so as to be rotatable around the corresponding pins 64.

The hammer 53 has a cylindrical recess 70 that recesses forward from the rear surface. The front portion of the spring 52 is in the recess 70. A washer 72 which is in contact with the front end surface of the spring 52 and a plurality of small balls 74, 74 . . . which are arranged in front of the washer 72, are interposed between the bottom (the front end portion) of the recess 70 and the front end portion of the spring 52.

The rear end portion of the spring 52 is in contact with a washer 75, and the washer 75 is in contact with the spindle bearing 68.

Balls 76, 76, which guide the hammer 53 mainly in the front and rear direction when the hammer 53 performs striking, are interposed between the hammer 53 and the front portion of the spindle 51 (FIG. 2).

The anvil 54 in front of the hammer 53 is formed to have extension parts 82, 82 each extending in the radial direction (the up and down direction in the drawing), in rear of a cylindrical section 80 extending in the front and rear direction.

An anvil bearing 84 supporting the anvil 54 is provided in front of the extension parts 82, 82 such that the anvil 54 is rotatable around the axis and cannot be moved in the axial direction. The anvil bearing 84 is held in a portion inward of the boss sections 7, 7 which are arranged in the front end portion of the motor housing 4.

A rear hole 86 extending forward from the rear surface is formed in the rear center of the anvil 54, and the front end portion of the spindle 51 is in the rear hole 86.

An inner hole formed rearward from the front surface in the cylindrical section 80 of the anvil 54 receives the rear portion of the shaft 55 such that rotation force can be transmitted. The cylindrical section 80 of the anvil 54 is linked with the rear portion of the shaft 55 by a spline structure.

The shaft 55 has a bevel gear teeth part 92 on the front side of a bar-shaped part 90 extending in the front and rear direction.

Around the bar-shaped part 90, shaft bearings 94, 94 are disposed on the front side and the rear side, respectively, and support the shaft 55 such that the shaft 55 can rotate around the axis of the shaft 55 itself. The shaft bearings 94 are attached to the gear housing 6. A cylindrical spacer 96 is provided between the shaft bearings 94, 94. The rear end portion of the rear shaft bearing 94 is held by bearing retainers 97a, 97b.

The bevel gear teeth part 92 has a U-like shape or a Y-like shape in which the longitudinal cross-sectional portion is opened forward. The front side portion of the outer circumference portion of the disk-like portion of the bevel gear teeth part 92 has a ring-like portion which protrudes forward. The ring-like portion is formed as a teeth section 98 in which a plurality of bevel gear teeth are formed. That is, in the bevel gear teeth part 92, a recessed section 99 which is recessed rearward is formed inward of the teeth section 98.

The bevel gear teeth part 92 reaches the angle head part 9.

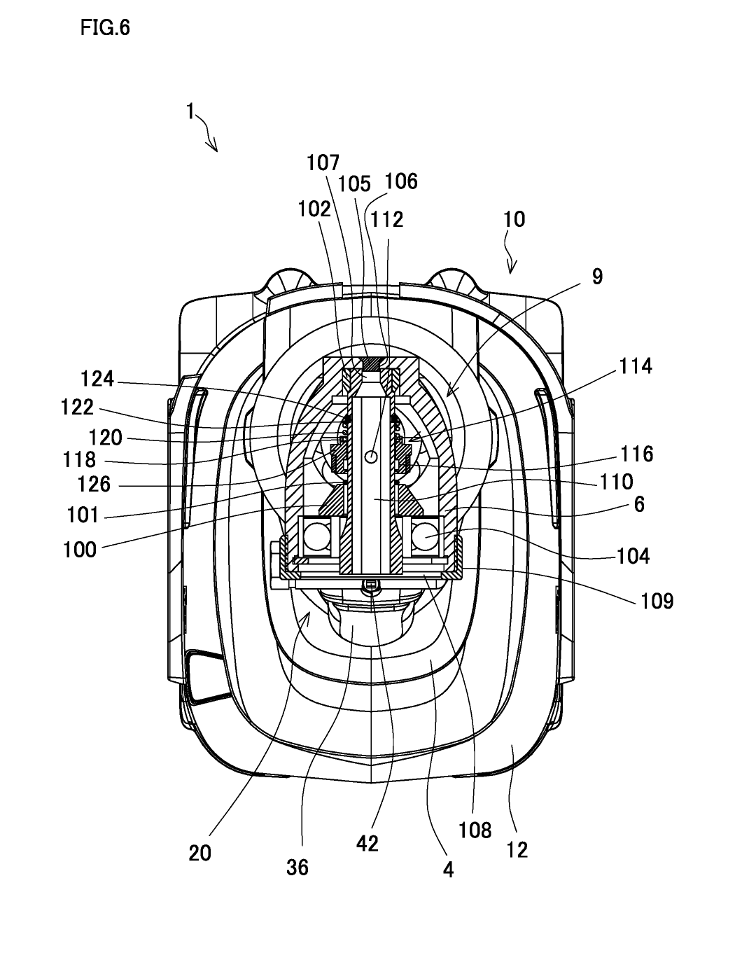

FIG. 6 is a center cross-sectional view of the angle head part 9.

The output shaft 20 is disposed in the angle head part 9.

The output shaft 20 is a cylindrical member extending in the up and down direction, and has a through hole passing therethrough in the axial direction. A bevel gear 100 having bevel gear teeth is fixed in the center portion of the output shaft 20 via a retainer 101. The bevel gear 100 meshes with the bevel gear teeth part 92 of the shaft 55, and drive force of the shaft 55 is transmitted to the output shaft 20 the central axis of which intersects the central axis of the shaft 55. Accordingly, the shaft 55 having the bevel gear teeth part 92 acts as a drive shaft. The bevel gear 100 and the bevel gear teeth part 92 form a bevel gear mechanism.

Around the upper end portion of the output shaft 20, an upper output bearing 102 is provided. At a position around the lower end portion of the output shaft 20 and below the bevel gear 100, a lower output bearing 104 is provided. The output shaft 20 is supported by the upper output bearing 102 and the lower output bearing 104 so as to be rotatable around its own axis.

The upper end portion of the hole in the cylindrical part of the output shaft 20 has an inner diameter narrower than that of the portion therebelow.

On the upper side of the output shaft 20, a cap 105 is provided. The cap 105 is a mushroom-shaped elastic member. The cap 105 is detachably mounted in a hole (a housing hole 106) which is provided in the gear housing 6 (immediately above the output shaft 20) and which has a shape corresponding to the cap 105, in a state where the axial portion of the cap 105 is positioned on the inner side (the lower side). The lower end portion of the axial portion is in the upper end portion (a communication hole 107) of the hole in the output shaft 20. The cap 105 covers the housing hole 106 and the communication hole 107. The housing hole 106 is connected to the communication hole 107.

In a portion of the gear housing 6, which corresponds to the lower end portion of the angle head part 9, a downward opening 108 is formed. At the outer side and the lower side of the opening 108, a bumper 109 which is made of an elastic material and which covers the opening 108 is placed. The gear housing 6 can be considered to include the bumper 109 (the bumper 109 is a component of the gear housing 6).

A portion other than the upper end portion in the cylinder of the output shaft 20 is a chuck part 110 that serves as a bit holding section capable of holding a not-illustrated bit (a tip tool) inserted from therebelow. That is, the output shaft 20 is a bit insertion member into which a bit can be inserted. The chuck part 110 is connected to the communication hole 107 which is the upper end portion of the through hole in the output shaft 20. The inner hole of the output shaft 20 at the chuck part 110 is a hexagonal hole.

The bevel gear 100 is disposed outside the chuck part 110. When the center axis along the front and rear direction of the shaft 55 is extended forward, the center axis is orthogonal to the chuck part 110.

The chuck part 110 has, at the center portion thereof, chuck balls 112, 112 corresponding to the small recesses of a bit such that the check balls 112, 112 oppose each other. The inner-side portion of each chuck ball 112 as a locking member can protrude from the wall of the chuck part 110, and can enter a small recess of an inserted bit to fix the bit. The chuck balls 112 enter the upper small recess of a bit (a bit formed in compliance with a predetermined standard) having two general small recesses on the upper side and the lower side.

The outer sides of the chuck balls 112, 112 in the chuck part 110 are covered by a cylindrical sleeve 114. The sleeve 114 is disposed above the lower output bearing 104 and the bevel gear 100.

A releasing section 116, which is recessed outward from the inner surface so as to be ring-shaped, is provided at the lower portion of the sleeve 114.

On the upper portion of the sleeve 114, a reception section 118 is provided which protrudes upward so as to be ring-shaped in a state where a gap is formed between the reception section 118 and the outer surface of the output shaft 20. The lower end portion of a spring 120 which is an elastic body is in the reception section 118. The upper end of the spring 120 is locked by a circlip 124 via a washer 122.

The center portion of the sleeve 114 is provided with a protrusion section 126 that protrudes outward so as to be ring-shaped with respect to portions thereabove and therebelow. A portion (the rear portion of the protrusion section 126) of the sleeve 114 is disposed in the recessed section 99 of the bevel gear teeth part 92 of the shaft 55.

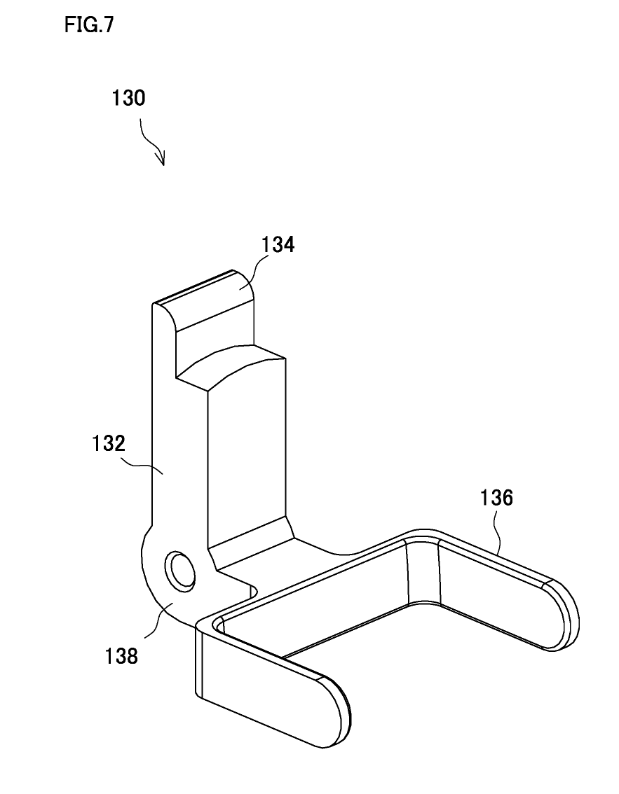

In front of the sleeve 114, an arm 130 as interlocking means is provided. FIG. 7 is a perspective view of the arm 130.

The arm 130 has an L-shaped longitudinal cross-section, as a whole, having a portion extending upward and a portion extending rearward. The portion extending upward is a lever part 132.

The upper end portion of the lever part 132 is an operation part 134 whose size (thickness) in the front and rear direction is smaller than a portion therebelow.

On the other hand, the rear end portion of the portion extending rearward is a connection part 136 having a U-shaped horizontal cross section. The (upper portion of the) connection part 136 is in contact with the (front lower portion of the) protrusion section 126 of the sleeve 114.

The corner portion of the arm 130 is formed as a bearing part 138 which has a cylindrical shape having the axis extending in the left and right direction.

A shaft 140 extending in the left and right direction is inserted in the bearing part 138 of the arm 130. The shaft 140 has a columnar shape corresponding to the hole shape of the bearing part 138, and is extended in the lower rear portion of a hole (an arm hole 141) extending in the up and down direction in the front end center of the gear housing 6. The end portions of the shaft 140 are attached to the gear housing 6.

The arm 130 is rotatable around the shaft 140. The arm 130 rotates from a standing position in which the lever part 132 stands in the up and down direction to a tilted position in which the lever part 132 is tilted from upper front toward the lower rear portion.

When the arm 130 is at the standing position, the lower portion and the rear portion of the lever part 132 closes the hole in the front end portion of the gear housing 6, the operation part 134 is apart from the outer surface of the gear housing 6, and a gap is generated relative to the gear housing 6.

When the arm 130 is at the tilted position, the connection part 136 lifts up the sleeve 114 via the protrusion section 126. At the tilted position, the lever part 132 receives, via the sleeve 114, repulsive force of the spring 120 which is contracted more greatly than at the standing position, and the repulsive force at the tilted position is higher than that at the standing position.

When the sleeve 114 is lifted up, the releasing section 116 reaches the positions of the chuck balls 112 and the chuck balls 112 enter the releasing section 116, so that the chuck balls 112 can be released to the outside. The action, toward the inner side, of the chuck balls 112 which are movable outward is reduced, and, if a bit is present, action onto the small recesses is reduced to release fixing of the bit, so that the bit can be easily removed. Accordingly, the sleeve 114 forms bit holding releasing means.

An example of an operation of the angle impact driver 1 as described above will be described.

When a user grasps the outer side of the housing 2 and pulls the switch lever 36 upward in a state where a bit is fixed in the chuck part 110, the upper portion of the plunger 34 enters the switch body 32 and the switch 14 is turned on. Then, power is supplied from the battery 10 to the motor 16 to rotate the rotor, and thus, the motor shaft 39 is rotated.

The rotation force of the motor shaft 39 is reduced by the planetary gears 62, 62 . . . , which revolve while rotating in the internal gear 60, and then, is transmitted to the spindle 51 via the pins 64, 64 . . .

The spindle 51 causes the anvil 54 and the shaft 55 to rotate. When the anvil 54 receives torque having a predetermined threshold value or higher value, the hammer 53 moves rearward, engagement between the hammer 53 and the anvil 54 is released, and the hammer 53 idles by half rotation to perform rotary striking. An operation such as rotary striking by the hammer 53 is adjusted by the spring 52.

The shaft 55 rotates (strikes), via the bevel gear teeth parts 92, 92, the output shaft 20 which forms an angle of 90° relative to the motor shaft 39, and rotates (strikes) the bit attached in the chuck part 110.

A bit can be attached and detached by operating the arm 130 when the switch 14 or the power supply is off.

When a finger is placed on (a gap between the front end outer surface of the gear housing 6 and) the operation part 134 of the arm 130 at the standing position and tilts the arm 130, the sleeve 114 moves upward along the output shaft 20 via the connection part 136 and the protrusion section 126 so that the chuck balls 112, 112 can enter the releasing section 116. Thus, fixing of the bit by the chuck balls 112, 112 is loosened. This state allows the bit to be easily removed. If the fixing by the chuck balls 112, 112 is excessively strong and the bit cannot easily enter the chuck part 110, this further facilitates attachment of the bit.

When an operation on the operation part 134 is stopped, the arm 130 returns to the standing position, by action of the spring 120 in contact with the sleeve 114.

In the case where, even when the arm 130 is at the tilted position, a bit is difficult to remove from the chuck part 110, the cap 105 is removed and a pin, etc. is put into the housing hole 106 and the communication hole 107, whereby the upper end of the bit can be pushed. Thus, the bit can be removed.

The angle impact driver 1 described above includes the output shaft 20 having the chuck part 110 capable of holding a bit, the shaft 55 that is provided so as to intersect the output shaft 20 and that transmits drive force to the output shaft 20, and the housing 2 (the gear housing 6) that accommodates the shaft 55. The entirety of the chuck part 110 is disposed in the housing 2. Accordingly, as compared to the case where the lower portion of the chuck part 110 is extended from the opening 108 in the gear housing 6, the height (the length in the direction of the output shaft 20) of the angle head part 9 can be reduced (shortened).

Furthermore, the output shaft 20 includes the bevel gear 100 which receives drive force from the shaft 55, and the chuck part 110 is disposed inside the bevel gear 100. Accordingly, the height of the angle head part 9 can be reduced.

The chuck part 110 is disposed in front of the shaft 55 so as to intersect the extended line of the center axis of the shaft 55. Accordingly, the height of the angle head part 9 can be reduced.

The sleeve 114 for releasing holding of a bit and the arm 130 connected to the sleeve 114 are provided, the sleeve 114 is accommodated in the housing 2 (the gear housing 6), and the front portion and the upper portion of the lever part 132 of the arm 130 is disposed outside the housing 2. Accordingly, while the height of the angle head part 9 is reduced by arranging the entirety of the sleeve 114 in the housing 2, the sleeve 114 can be operated by the arm 130.

Since the arm 130 has an L-shaped cross section and has the bearing part 138 at the corner portion thereof, an operation for holding and releasing a bit can be easily performed by leverage using the bearing part 138 as a fulcrum.

Since the arm 130 includes the operation part 134 which is apart from the outer surface of the housing 2 (the gear housing 6), a finger, etc. can be placed in a gap between the operation part 134 and the housing 2, so that an operation of the arm 130 becomes easier.

In addition, the output shaft 20 has the communication hole 107 connecting to the chuck part 110, and the housing 2 (the gear housing 6) has the housing hole 106 connecting to the communication hole 107. Accordingly, a pin, etc. can reach the chuck part 110 through the housing hole 106 and the communication hole 107. Thus, if a bit bites the chuck part 110, the bit can be pushed and removed.

Since the cap 105 which covers both the communication hole 107 and the housing hole 106 is provided, even if these holes are formed, dust is prevented from entering the holes during non-use time.

The recessed section 99 which is recessed rearward is formed inside the teeth section 98 of the bevel gear teeth part 92, and (a portion of) the sleeve 114 which is the internal mechanism of the angle head part 9 is disposed in the recessed section 99. Therefore, arrangement of the internal mechanism becomes efficient, and the angle head part 9 becomes compact, and particularly, becomes compact in the front and rear direction.

The chuck part 110 (the output shaft 20) holds, with the chuck balls 112, the upper small recess in a bit having two small recesses (the held points). In this case, the sleeve 114 which is a bit holding (releasing) mechanism can be positioned at a higher position, as compared to the case where the lower small recess is held. Thus, the entirety of the output shaft 20 and the chuck balls 112 can be arranged in the housing 2, and the height of the angle head part 9 is reduced.

Further, the motor 16, the shaft 55 which is driven by the motor 16, the output shaft 20 which forms an angle relative to the shaft 55 and which is driven by the shaft 55, the hexagonal hole formed in the output shaft 20, the chuck balls 112, 112 which can protrude from the wall defining the hexagonal hole, and the housing 2 that supports the output shaft 20 and accommodates the chuck balls 112, 112 are provided. Therefore, since at least the arrangement positions of the chuck balls 112, 112 in the output shaft 20 are positioned in the housing 2, the height of the angle head part 9 can be reduced.

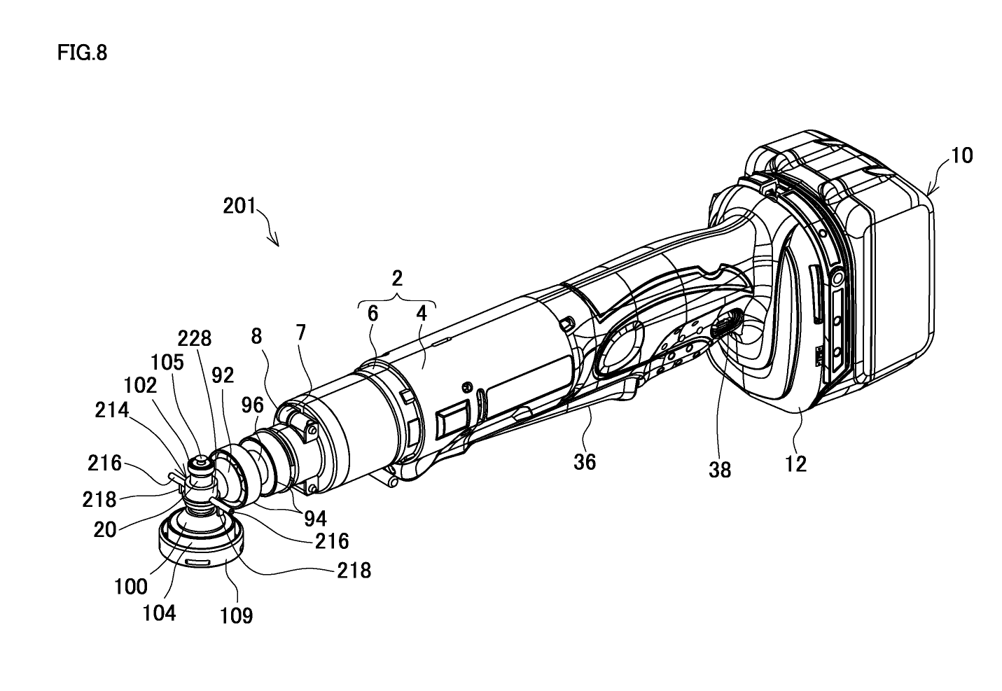

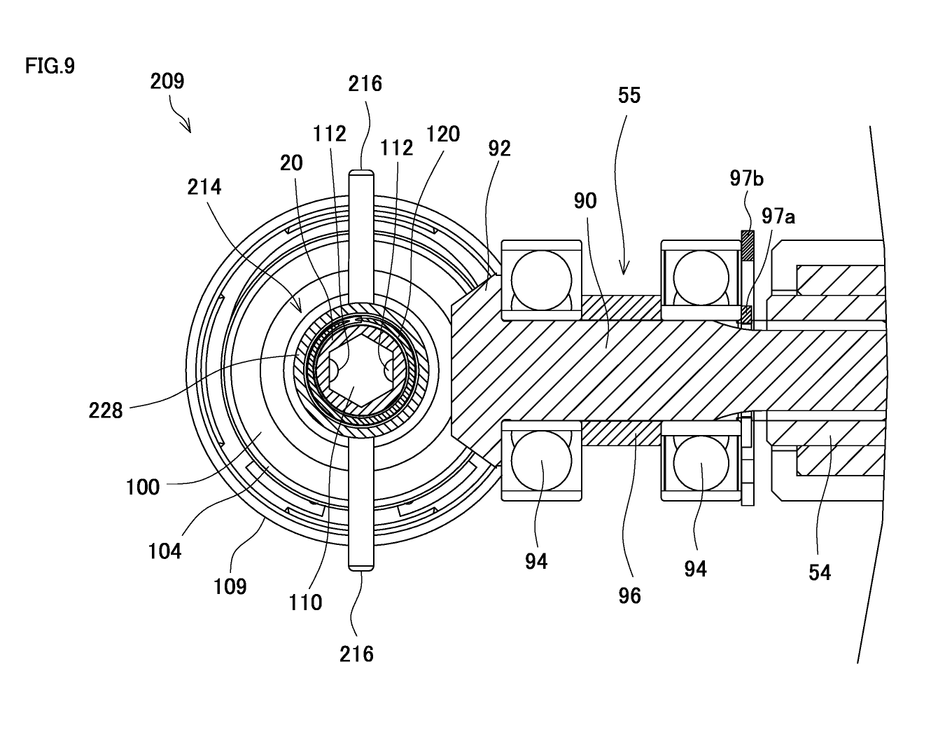

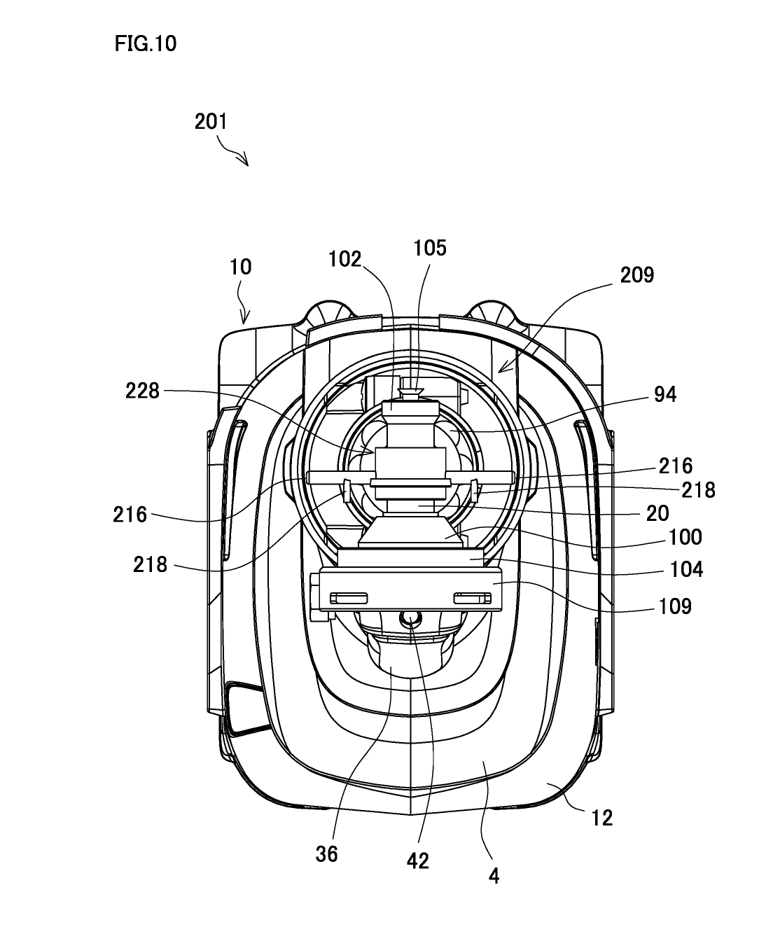

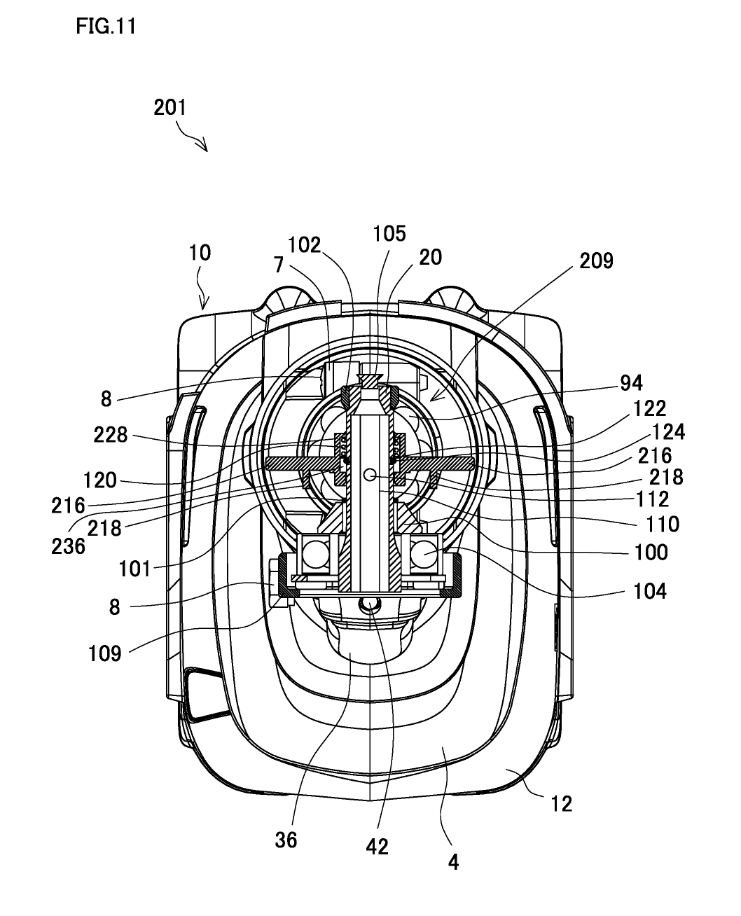

FIG. 8 illustrates an angle impact driver 201 according to a second embodiment of the present invention and corresponds to FIG. 1. FIG. 9 is a horizontal center cross-sectional view of an angle head part 209 according to the second embodiment. FIG. 10 illustrates the angle impact driver 201 according to the second embodiment and corresponds to FIG. 5. FIG. 11 illustrates the angle impact driver 201 according to the second embodiment and corresponds to FIG. 6. In these drawings, illustration of the gear housing 6 is omitted.

The angle impact driver 201 according to the second embodiment has the same structure as in the first embodiment except for the structure of a sleeve 214 in an angle head part 209 and the surrounding structure. Hereinafter, the same components as described in the first embodiment are denoted by the same reference numerical, and the description thereof is omitted as appropriate.

The angle head part 209 according to the second embodiment is not provided with the arm 130 and the arm hole 141, unlike in the first embodiment.

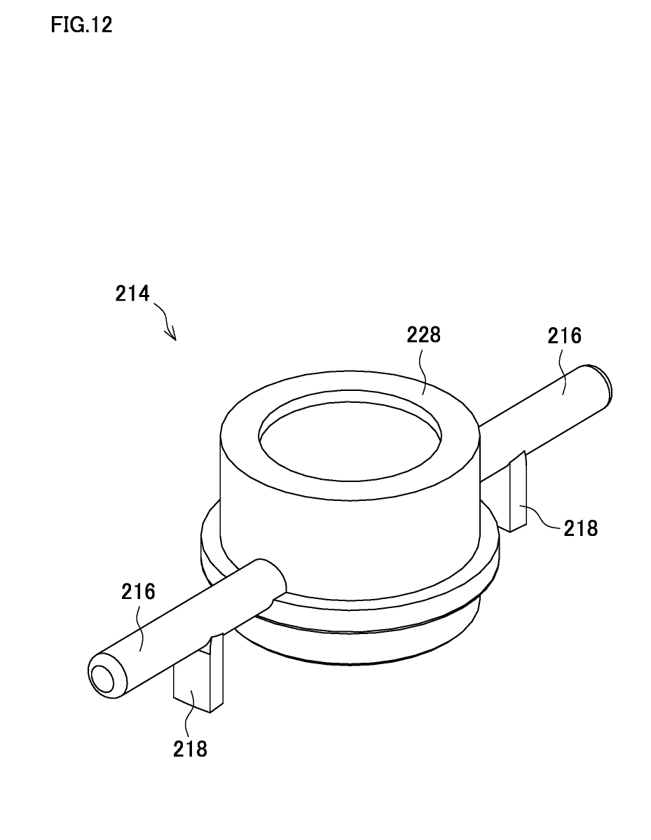

As also illustrated in FIG. 12, column-like operation bars 216, 216 which protrude outward from the cylindrical outer surface are connected to the left and right sides of the sleeve 214 so as to be integrated with the sleeve 214. Each of the operation bars 216 has, at the center portion thereof, a guide 218 protruding downward from the lower portion. The gear housing 6 includes ribs (not illustrated) for guiding the guides 218. Each guide 218 and each rib are oriented in the moving direction (up and down direction) of the operation bar 216 or the sleeve 214. The gear housing 6 has bar holes (not illustrated) through which the respective operation bars 216 pass. The front end portion (the outer portion) of each operation bar 216 is exposed from the corresponding bar hole.

The spring 120, the washer 122, and the circlip 124 are covered with a reception section 228 at the upper portion of the sleeve 214. The washer 122 and the circlip 124 are disposed on the lower end side of the spring 120. The upper end portion of the spring 120 is in contact with the upper inner surface of the reception section 228. Below the circlip 124, a releasing section 236 is provided as a space which does not reach the entirety of the outer side portions of the chuck balls 112 when the sleeve 214 is at the upper position, and reaches the entirety of the outer side portions of the chuck balls 112 when the sleeve 214 is at the lower position. Each of the bar holes is elongated in the up and down direction such that the corresponding operation bar 216 can move in the up and down direction (can move in the compression direction of the spring 120 and in the opposite direction).

The angle impact driver 201 according to the second embodiment includes the output shaft 20 having the chuck part 110 capable of holding a bit, the shaft 55 that is provided so as to intersect the output shaft 20 and that transmits drive force to the output shaft 20, and the gear housing 6 that accommodates the shaft 55. The entirety of the chuck part 110 is disposed in the gear housing 6. Accordingly, the height of the angle head part 209 can be reduced.

The angle impact driver 201 further includes the sleeve 214 for releasing holding of a bit, and the operation bars 216, 216 integrated with the sleeve 214. The sleeve 214 is accommodated in the gear housing 6. An end of each operation bar 216 is disposed outside the gear housing 6. Accordingly, while the height of the angle head part 209 is reduced by arranging the entirety of the sleeve 214 in the gear housing 6, the sleeve 214 can be operated with the operation bars 216. That is, although the sleeve 214 is disposed in the gear housing 6, the operation bars 216 are moved in the compression direction (the downward direction) of the spring 120 to lower the sleeve 214, and the chuck balls 112 can enter the releasing section 236 in the sleeve 214, whereby fixing of a bit is released.

Since the operation bars 216 include the respective guides 218, the sleeve 214 can be prevented from being inclined to be caught by the output shaft 20, etc. An operator can smoothly operate the sleeve 214.

The present invention is not limited to the above embodiments, and, for example, the following modification may be devised, as appropriate.

The output shaft may be provided so as to protrude from the housing while the chuck balls (locking members) are disposed in the housing.

The cap for closing the housing hole connected to chuck part in the output shaft may have a screw thread (a screw section) and the housing hole may have a screw groove (a screw receiving section) corresponding to the screw thread. In this case, the cap is easily attached by being screwed.

Alternatively, the cap may have a claw (locking section), and the housing hole may have a hole or a bore (section to be locked) at which the claw hooks. Alternatively, the locking section may be a bore or a hole, and the section to be locked may be a claw. Alternatively, both of the locking section and the section to be locked may be claws locked by each other. The claw may be a protrusion having another shape such as a mushroom-like shape.

The number of housing sections, the number of planetary gears to be mounted, the number of bearings to be mounted, the number of poles of the magnet of the brushless motor, the number of coils, or the number of elements may be increased or decreased. In addition, the type of the switch of the switch lever may be changed, the battery may be changed to a rechargeable battery other than a lithium ion battery, to a primary battery, or to a battery having a plug to be connected to a commercial power source, or a striking mechanism may be omitted, for example. That is, for example, the number, the arrangement, the material, the size, the type, the kind, or the wiring route of the components can be changed as appropriate.

Moreover, the number of the lead wires, the number of the elements, and the number of the coils of the brushless motor can be increased or decreased, and the number of the types thereof can be increased or decreased. In particular, the number of lead wires can be increased or decreased, as appropriate, according to a product to be implemented.

The present invention is also applicable to an angle tool other than an angle impact driver.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. An angle tool comprising:
an output shaft including a bit holding part capable of holding a bit;
a drive shaft, provided so as to intersect the output shaft, configured to transmit drive force to the output shaft; and
a housing configured to accommodate the drive shaft,
the entirety of the bit holding part being disposed in the housing.

2. The angle tool according to claim 1, wherein
the output shaft includes a gear that receives drive force from the drive shaft, and
the bit holding part is disposed inside the gear.

3. The angle tool according to claim 1, wherein
the bit holding part is disposed in front of the drive shaft so as to intersect an extended line of a central axis of the drive shaft.

4. The angle tool according to claim 1, further comprising
a bit holding releaser for releasing holding of the bit, and
a linking unit connected to the bit holding releaser, wherein
the bit holding releaser is accommodated in the housing, and at least a part of the linking unit is disposed outside the housing.

5. The angle tool according to claim 4, wherein
the linking unit is an arm that has an L-shaped cross-section and has a bearing part at a corner portion of the arm.

6. The angle tool according to claim 1, wherein
the output shaft has a communication hole connected to the bit holding part, and the housing has a housing hole connected to the communication hole.

7. The angle tool according to claim 6, further comprising
a cap that covers at least one of the communication hole and the housing hole.

8. The angle tool according to claim 7, wherein
the cap has a screw section and the housing hole has a screw receiving section which meshes with the screw section.

9. An angle tool comprising:
a motor;
a drive shaft that is driven by the motor;
an output shaft configured to form an angle relative to the drive shaft and be driven by the drive shaft;
a hexagonal hole formed in the output shaft;
a locking member capable of protruding from a wall defining the hexagonal hole; and
a housing configured to support the output shaft and accommodate the locking member.
